(19) United States
(12) Patent Application Publication
(10) Pub. No.: US 2015/0220913 A1
(43) Pub. Date: Aug. 6, 2015

(54) Multi-Use Card and System

(71) Applicant: Microsoft Corporation, Redmond, WA (US)

(72) Inventors: Jie Liu, Medina, WA (US); Neal Alan Bernstein, Mercer Island, WA (US); William Alexander Spencer, JR., Redmond, WA (US); Nissanka Arachchige Bodhip Priyantha, Redmond, WA (US)

(73) Assignee: Microsoft Corporation, Redmond, WA (US)

(21) Appl. No.: 14/172,027

(22) Filed: Feb. 4, 2014

(51) Int. Cl. G06Q 20/34

(52) U.S. Cl. CPC G06Q 20/3572; G06Q 20/341

(57) ABSTRACT

A multi-use card is presented. The multi-use card can be selectively configured to operate and/or function as any one of a plurality of associated cards (including credit cards, identity cards, access cards, membership cards, loyalty cards, and the like). The multi-use card can also be configured to display one or more messages from third parties on a display area on one or more surfaces of the card. The multi-use card includes communication abilities to communicate with one or more external computing devices by way of near field communications. The multi-use card is configured with associated cards and messages via the near field communications. Additionally, the multi-use card includes a power source that is charged by way of near field communications with the card.

### BACKGROUND

Some reports suggest that the typical adult now has 8 credit cards, at least several of which are always carried around by the person. Similarly, these same people typically have multiple loyalty cards from various vendors which, through use, typically accrue benefits to the person. As with credit cards, a person will typically carry at least some of his/her loyalty cards. In addition to credit cards and loyalty cards, the typical person is also issued membership cards, identity cards, access cards, library cards, and the like. In the end, wallets and purses become loaded with the many cards that one accumulates.

Several services have offered adaptable credit cards—a single card that can be configured to operate as one of many credits cards. However, current adaptable credit cards are limited in scope and usable lifetime.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, a dynamic use card is presented. The dynamic use card can be selectively configured to operate and/or function as a single card or any one of a plurality of associated cards (including credit and/or debit cards, identity cards, access cards, membership cards, loyalty cards, gift cards, phone cards, and the like). They dynamic use card can also be configured to display one or more messages from third parties on a display area on one or more surfaces of the card. The dynamic use card includes communication abilities to communicate with one or more external computing devices by way of Near Field Communications (NFC). The dynamic use card is configured with associated cards and messages via the near field communications. Additionally, the multi-use card includes a power source that is charged by way of energy harvested from the Near Field Communications.

According to additional aspects of the disclosed subject matter, a user manages a multi-use card by way of applications (or apps) on the user's mobile device. The user's mobile device includes one or more executable components for managing the storage of associated cards on the multi-use card, as well as one or more executable components for receiving, filtering, formatting and storing messages from third parties on the multi-use card. According to various embodiments, the mobile device may obtain third party messages by way of a messaging service. One or more executable modules are configured to manage the power source of the multi-use card, including sending near field communications to the card for purposes of charging the card's power source/battery.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIGS. 1A-1C are pictorial diagrams illustrating various configurations of exemplary multi-use cards;

FIG. 2 is a block diagram illustrating exemplary components of a multi-use card according to aspects of the disclosed subject matter;

FIG. 3 is block diagram illustrating an exemplary network environment suitable for implementing aspects of the disclosed subject matter, particularly in regard to providing messages to a multi-use card for display to a user associated with the card;

FIGS. 4A and 4B are pictorial diagrams illustrating exemplary mobile device cases for holding a user's mobile device and further configured to include one or more locations in which a multi-use card may be carried such that the card is within the requisite distance for near field communication/charging;

FIG. 5 is a flow diagram illustrating an exemplary routine, as implemented by a messaging service, for receiving messages from network entities, such as network entities, for display on a target user's multi-use card;

FIG. 6 is a flow diagram illustrating an exemplary routine, as implemented on a user's mobile device, for receiving messages to be displayed on a person's multi-use card;

FIG. 7 is a flow diagram illustrating an exemplary routine, as implemented on a multi-use card, in regard to receiving messages for display on the card;

FIG. 8 is a flow diagram illustrating an exemplary routine, as implemented on the multi-use card, for updating the usage tracking information;

FIG. 9 is a flow diagram illustrating an exemplary routine, as executed on a mobile device, for receiving usage information from a multi-use card and reporting the information to a messaging service;

FIG. 10 is a flow diagram illustrating an exemplary routine, as executed by a messaging service, for receiving track usage information and reporting the information to one or more network entities;

FIG. 11 is a block diagram illustrating exemplary components of a mobile device suitable for implementing aspects of the disclosed subject matter; and

FIG. 12 is a block diagram illustrating exemplary components of a messaging service suitable for implementing aspects of the disclosed subject matter.

### DETAILED DESCRIPTION

For purposes of clarity, the term “exemplary” in this document should be interpreted as serving as an illustration or example of something, and it should not be interpreted as an ideal and/or a leading illustration of that thing.

The term “application” should be understood to refer to a set of executable instructions and corresponding data that carry out one or more particular tasks on a computer system. The term “app,” while also referring to a set of executable instructions and corresponding data to carry out one or more particular tasks, is often singular in its focus of tasks and is typically smaller in size and in the amount of computing resources that are required for its execution.

For purposes clarity, a multi-use card refers to a card having capabilities and components as described below, include the ability to be used or operate as any one of multiple credit cards. Additionally, a multi-use card may be used or operate as any one of multiple identity cards, loyalty cards, membership cards, access cards, a message card (a card configured to deliver a message/communication to the user), and the like. For purposes of clarity, each of the credit cards, loyalty cards, membership cards, access cards, smart cards (including cards with electronic circuitry), and the like that may be represented by the multi-use card is referred to as an associated card.

By way of definition, a message card is a physical card which is able to be dynamically configured to display a message to the user/person on one or more surfaces of the card. As indicated above, according to aspects of the disclosed subject matter that multi-use card is also a physical card and may be used or operate as a message card. Further, the multi-use card, as described herein, may be configured to operate as and/or used as though it were any one of a plurality of cards (referred to associated cards) that are stored in a memory on the multi-use card. By way of illustration and not limitation, a message may comprise text, images, coded data (such as bar codes, QR codes, and the like), and-/or video. Messages displayed on a multi-use card may include both commercial and non-commercial messages. Commercial messages include, by way of illustration and not limitation, advertisements, coupons, offers, rebates, and the like. Of course, when a commercial message includes coded data, the coded data may be optically scanned such that coupons can be redeemed, rebates and or loyalty points may be awarded, and the like. Non-commercial messages may include, by way of illustration, communications from other persons and/or entities, including businesses, where the subject matter is not specifically directed at a commercial undertaking. For example, a support organization with which the user of the multi-use card is associated may send a message (via the messaging service 100) containing words of encouragement to the person. Similarly, a business—detecting that the user of the multi-use card is in the vicinity—may send a message comprising an unadvertised special. Of course, these examples are illustrative only and should not be construed as limiting with regard to the nature and types of messages delivered to the multi-use card. On suitably configured multi-use cards, audio messages may also be provided.

According to various embodiments of the disclosed subject matter, a multi-use card largely conforms to ISO and IEC card standards 4909, 7810, 7811, 7813, and ISO8583 though a given multi-use card may or may not include embossed numbers or letters. A multi-use card may or may not include magnetic strip or a SIM and SIM contacts on its surface. As those skilled in the art will appreciate, a SIM is an acronym for subscriber identity module (or subscriber identification module) and refers to circuitry (sometimes removable circuitry) that stores an international mobile subscriber identity (IMSI) and a related key used to identify and authenticate subscribers or, in the case of a multi-use card, the user of the card. SIM contacts are electrical contacts for interacting with the SIM. As mentioned above, a multi-use card is dynamic in that the card can represent (be configured to be used or operate as) any one of its associated cards at any given time. Typically, though not exclusively, a multi-use card may store, on the card, sufficient data/information of the associated cards such that the multi-use card can reconfigure itself to operate as any one of the associated cards. According to various embodiments of the disclosed subject matter, a user/person associated with a multi-use card can direct the card to switch between the stored associated cards such that the user need only carry a single multi-use card rather than the multiple associated cards.

Regarding the magnetic strip, according to various embodiments and configurations, the multi-use may be suitably designed to be able to configure the magnetic strip. However, in alternative embodiments, the magnetic strip may be fixed as associated with a single service (a credit card provider, a vendor of a loyalty program, etc.)—such as an issued credit card. However, even in embodiments with the magnetic strip being fixed to a particular service, the multi-use card may include elements that enable the card to operate as one of the associated cards, including (by way of illustration and not limitation) presenting messages on the multi-use card, charging the power source of the multi-use card via captured NFC energy, capturing point-of-sale and other transaction information, interacting with loyalty programs and/or generally communicating with vendors (via a mobile device) regarding the card's use, and the like.

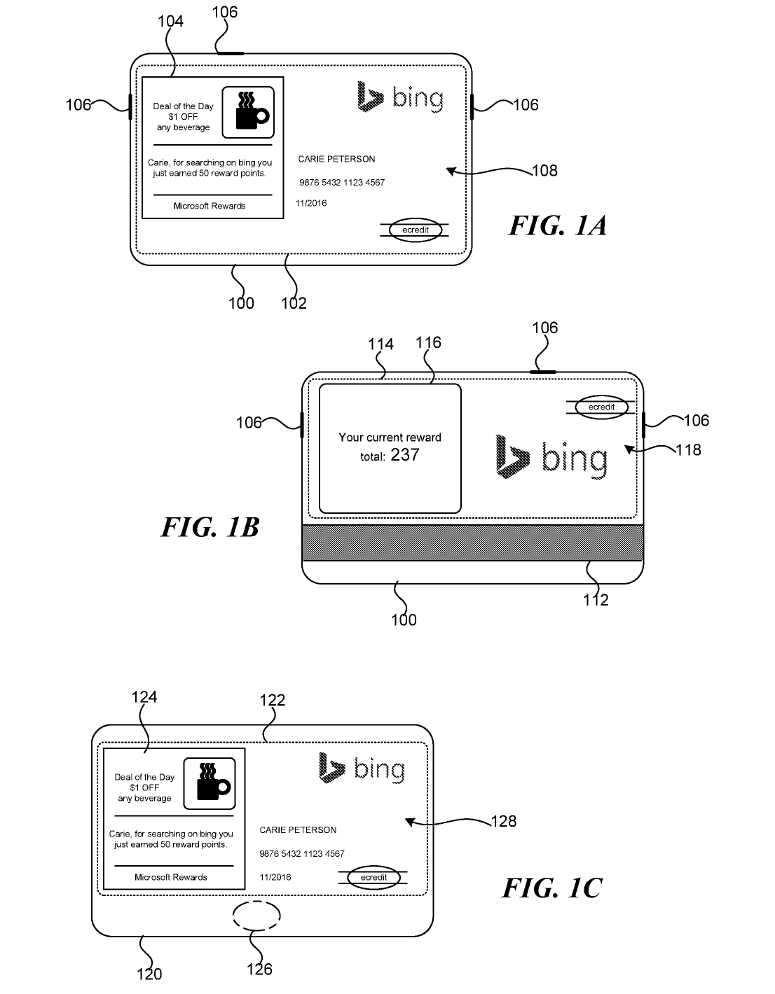

FIGS. 1A-1C are pictorial diagrams illustrating various configurations of exemplary multi-use cards. Turning first to FIG. 1A, this figure illustrates one side of a multi-use card 100. The multi-use card includes a displayable area 102 in which information may be displayed, including messages as well as visual indicators as to how the multi-use card 100 is configured (i.e., the associated card for which the multi-use card 100 is configured to operate.) As shown in FIG. 1A, the displayable area 102 of the multi-the use card 100 includes visual indicators 108 regarding the associated card, for which the multi-use card is configured, as well as a message area 104 in which messages from third parties may be displayed. Also shown on the multi-use card 100 are user controls by which the multi-use card may be selectively configured to operate as one of the associated cards and/or to display one of a plurality of messages. In particular, FIG. 1A includes touch contacts 106 which may be used (in various combinations) by the person associated with the multi-use card to change the display of the message displayed in the message area 104 and/or to cause the multi-use card to reconfigure itself to operate as another associated card.

FIG. 1B illustrates a pictorial diagram of the reverse side of the multi-use card 100 of FIG. 1A. As can be seen in FIG. 1B, the multi-use card may include another, second display area 114 in which content may be displayed, as well as a magnetic stripe area 112 which is common to most ISO 7810 conforming cards, and additional area for displaying visual indicators 108 regarding the associated card (which may or may not be the same information—or even the same message—as displayed on the front side of the multi-use card.) As with FIG. 1A, FIG. 1B illustrates that the display area 114 is partitioned to include indicia 118 of the associated card to which the multi-use card is configured as well as a message area 116 for displaying a message. Frequently, though not exclusively, the indicia 118 and the displayed message are independent of each other. Of course, while FIGS. 1A and 1B show a display area on either side of the card, in various embodiments a multi-use card may or may not include a display area on both sides. According to aspects of the disclosed subject matter, a first message may be displayed in a display area (such as message area 104) on one side of the multi-use card while a second message may be displayed on the other side of the multi-use card.

As should be appreciated, in various embodiment the display of a message in a display area, such as display area 116 of FIG. 1B, is independent of which associated card the multi-use card is selectively configured. As will be appreciated, in configuring itself to operate as an associated card, the multi-use card 100 will typically encode the magnetic stripe 112 consistent with the information that would be found in a magnetic stripe of the corresponding associated card.

Of course, the multi-use card 100 of FIGS. 1A and 1B is illustrative of the various configurations of a multi-use card and should not be viewed as limiting. For example, FIG. 1C illustrates an alternatively configured multi-use card 120 that includes a display area 122 which can be partitioned into an area 128 for display associated card indicia as well as a message area 124.

As an alternative to the contacts 106 of FIGS. 1A and 1B, the multi-use card 120 includes a touch area 126 which may be configured such that the user/person associated with the card can cause the card to reconfigure as one the various associated cards and/or display another message in the message area 124. Of course, in alternative embodiments, a user mobile device associated with the user person may be used to configure a multi-use card, including configuring the multi-use card to one of the associated cards and/or messages.

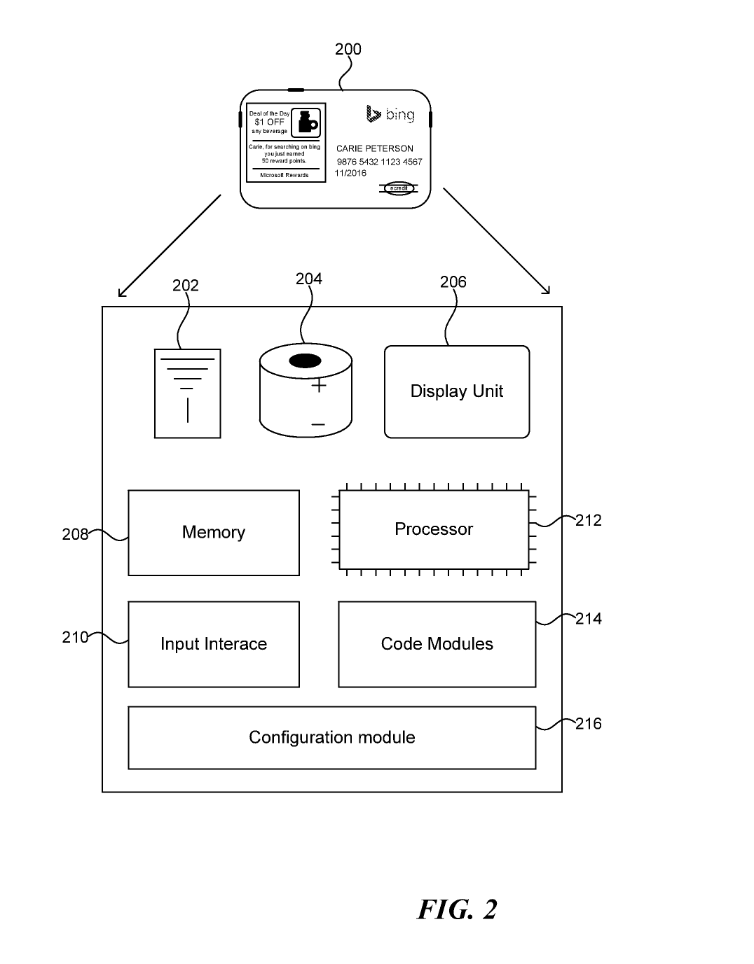

FIG. 2 is a block diagram illustrating exemplary components of a multi-use card 200 according to aspects of the disclosed subject matter. In particular, the multi-use card 200 includes an antenna 202 by which the card may receive communications from the associated persons mobile device as well as received near field communication (NFC) signals that are used to charge an internal power source, such as the battery 204, included on the card. As those skilled in the art will appreciate, near field communication corresponds to a set of standards for mobile phones and devices to establish radio communication with each other when in close proximity, usually no more than a few inches. Moreover, charging a battery from NFC signals is known in the art. While not show in FIG. 2, the battery 204 includes circuitry for providing power to the multi-use card 200 as well as circuitry for charging the battery based on energy harvested from the received NFC signals.

The multi-use card 200 also includes a processor 212 and a memory 208. The processor executes one or more code modules 214 in order to reconfigure the multi-use card as one of the associated cards display messages received from third parties, as well as track usage information and/or display information regarding an associated card or a displayed message. While illustrated as being separate for purposes of description, the code modules 214 may be stored within the memory 208 on the multi-use card 200. Also included in the multi-use card 200 is a display unit 206 and an input interface 210. By way of the display unit 206, both indicia regarding the associated card to which the multi-use card is configured as well as messages in a message area are presented to the associated user. The input interface 210 provides the mechanisms by which the person associated with the dynamics use card 200 can alternate between messages and/or associated cards. As shown in FIGS. 1A-1C, the input interface 210 may include contacts 106, touch-sensitive buttons 126, and the like.

Also included as part of the multi-use card 200 is a configuration module 216. The configuration module includes the circuitry, executable code, and devices that enable the multi-use card to configure itself to operate as one of the associated cards. In particular, the configuration module 216 is able to configure the magnetic strip 112 to encode the information that enables the multi-use card to function as an associated card.

As indicated above, a user manages the multi-use card primarily through one or more mobile devices, such as a tablet computer, a mobile phone, a combination device of a mobile phone and tablet (referred to as a phablet), a laptop computer, and the like. Indeed, the user mobile device includes one or more apps or applications that manage the content on the multi-use card, such as by way of illustration and not limitation adding or removing associated cards from the multi-use card, adding or removing messages for display by the multi-use card, and the like. A user may also control what associated card is typically selected by the multi-use card (i.e., the multi-use card is configured as the typically selected associated card), establish preferences for filtering messages for display on the card, managing the display of messages on the card, and obtaining usage data with regard to associated cards and displayed messages. In this manner, the user's mobile device becomes a gateway by which other entities may submit messages for display and receive usage data.

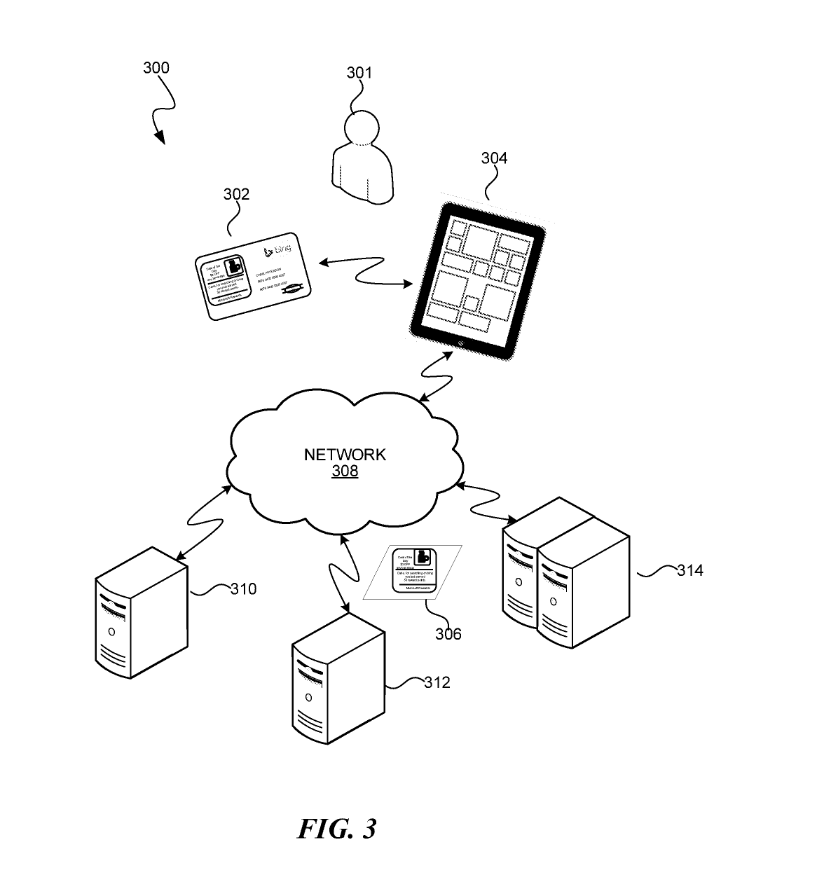

FIG. 3 is a block diagram illustrating an exemplary network environment 300 suitable for implementing aspects of the disclosed subject matter, particularly in regard to providing messages to a multi-use card 302 for display to a user 301 associated with the card. Indeed, as suggested above, the exemplary network environment 300 includes a user mobile device 304 by which the user 301 can manage the content that is available on the multi-use card 302. The mobile device 304 communicates with the multi-use card 302 by way of wireless communication including, but not limited to, near field communication. The user 301 is able to control the information (messages) that is displayed on the multi-use card 302 by establishing one or more rules and or preferences for receiving messages from other networked entities, such as network entities 310-312.

According to various embodiments of the disclosed subject matter network entities, such as network entities 310-312, communicate with a messaging service 314 two submit messages for display on a user's multi-use card 302. These network entities submit their messages, such as message 306 over the network 308 to the messaging service 314. Typically, the message 306 identifies or is accompanied with information that identifies the particular user 301 for which the messages intended. The messaging service 314 may be configured by the user 301 to filter messages submitted by networked entities. Similarly, the messaging service may be responsible for formatting any messages, such as message 306, for display on the user's multi-use card 302. After processing the message 306, the messaging service 314 forwards message on to the user's mobile device, such as mobile device 304. As discussed already, one or more applications or apps on the mobile device 304 may further process and or filtered the messages it receives, such as message 306 according to user preferences, rules, and the like. After processing his messages, the information can be loaded onto the multi-use card 302 for display to the user 301. The mobile device 304 may configure the multi-use card to display the message 306 immediately or set conditions upon which the message should be displayed. Of course, according to aspects of the disclosed subject matter, the user 301 may select which message is displayed on the multi-use card 302, as well as selecting which associated card for which the multi-use card is configured to operate.

In addition to sending information to the multi-use card 302, usage data (including display information indicating times that a particular message is displayed) may be gathered and periodically obtained by the user's mobile device 306. This information is then transmitted back to the messaging service 314 for additional analysis as well as for potential distribution to network entities such as network entities 310 and 312.

While FIG. 3 and the discussion above are made in regard to the use of a messaging service 314 acting as a front to network entities and receiving messages for display on the user's multi-use card 302, in an alternative embodiment a messaging service 314 is not used. In this alternative embodiment, network entities, such as network and keys 310-312, submit a message such as message 306 directly to one or more user mobile devices associated with the user 301.

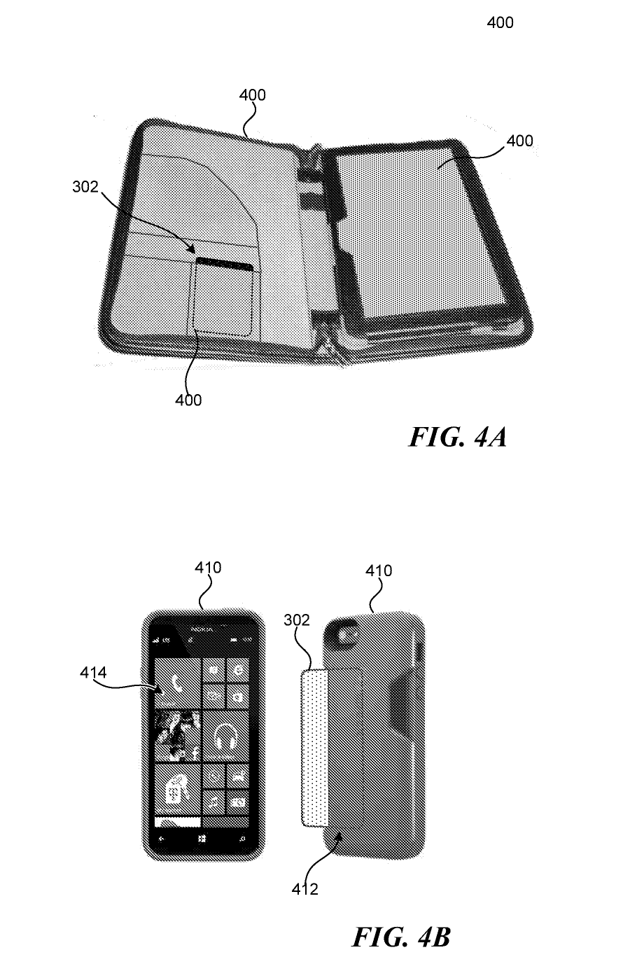

As mentioned above, near field communication typically occurs between devices that are in close proximity to each other. To facilitate communication between a multi-use card 302 and a user mobile device and according to various aspects of the disclosed subject matter, the case or folder for the user's mobile device, such as mobile device 304, is configured to include a sleeve or location to hold a multi-use card 302. FIGS. 4A and 4B are pictorial diagrams illustrating exemplary mobile device cases for holding a user's mobile device and further configured to include one or more locations in which a multi-use card may be carried such that the card is within the requisite distance for near field communication/charging. For example, FIG. 4A illustrates a portfolio case 400 that includes a mobile device area 404 in which a tablet computer or phablet, such as tablet computer 304, may be carried. Included in the portfolio case 400 is a sleeve 402 in which a multi-use card 302 may be inserted and carried. As will readily be appreciated, when the portfolio case 400 is closed, the multi-use card 302 in the sleeve 402 will be in close proximity to the mobile device such that near field communication and charging can occur. Similarly, FIG. 4B illustrates an alternative mobile device case 410. In this example, the mobile device case 410 is configured to hold a mobile phone 414 (including smartphones). On the back side of the mobile device case 410 is a slot 412 into which a multi-use card 302 may be inserted thereby placing the card in close proximity to the mobile device and enabling near field communications and charging (by harvesting energy from the near field communications).

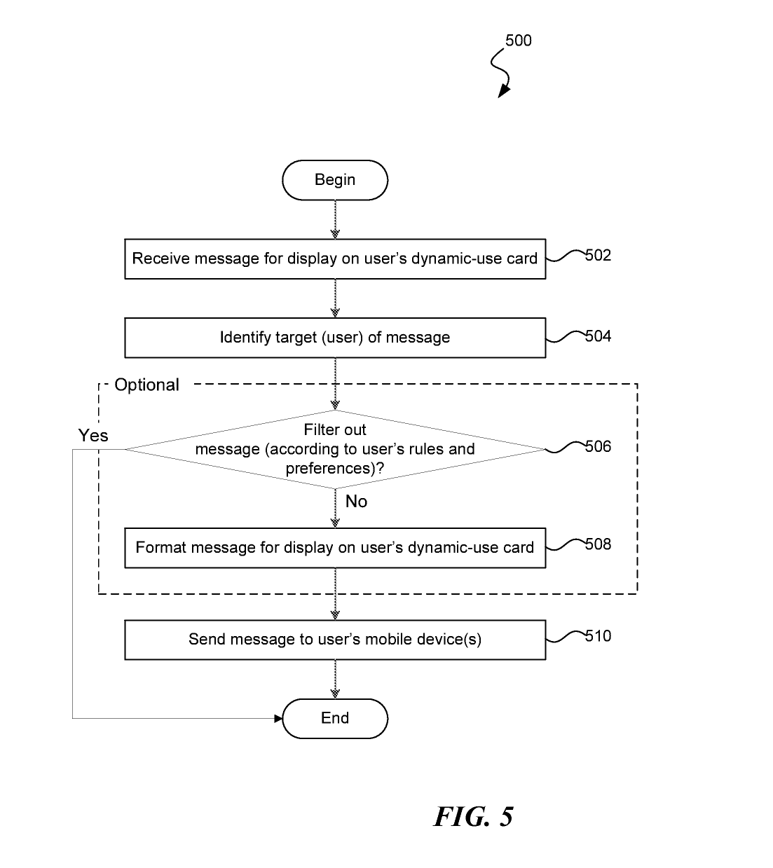

Turning now to FIG. 5, FIG. 5 is a flow diagram illustrating an exemplary routine 500, as implemented by a messaging service 314, for receiving messages from network entities, such as network entities 110-112, for display on a target user's multi-use card 302. Beginning at block 502, the messaging service receives a message 306 from a network entity for display on a user's multi-use card. At block 504, considering that the messaging service 314 will provide similar services to multiple persons/users, the messaging service identifies the target user 301 of the received message 306.

At decision block 506, the messaging service 314 determines whether to filter out the received message 306 based on any rules and/or preferences established by the target user 301 with the messaging service. If the message is filtered out, the routine 500 does not forward the message 306 to the target user 31 and simply terminates. However, if the received message 306 is not filtered out, the routine 500 proceeds to block 508. At block 508, the messaging service formats the received message 306 and sends/forwards the message to the target user's mobile device 304. Thereafter, the routine 500 terminates.

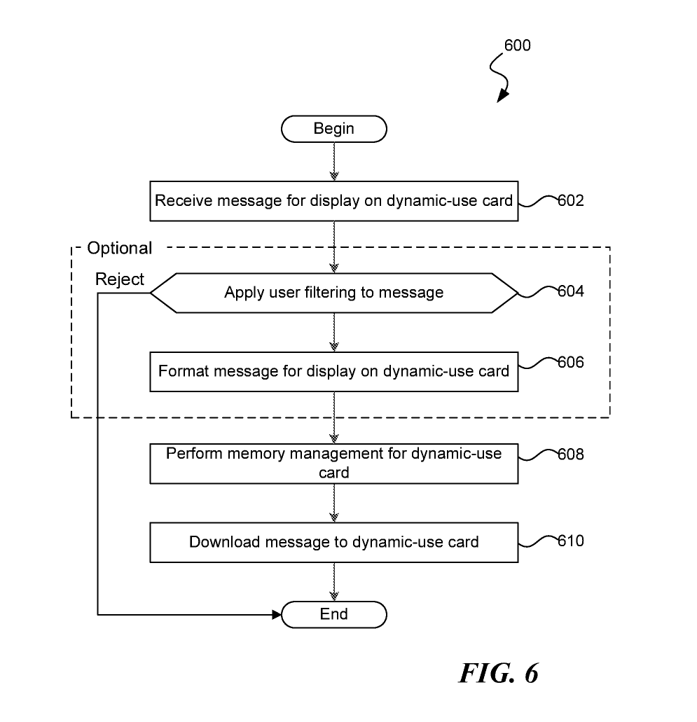

Regarding decision block 506 and block 508, these two are identified in FIG. 5 as being optional. According to embodiments of the disclosed subject matter, the messaging service 314 may be configured to filter out and format the received messages from network entities, as described above. However, in alternative embodiments the messaging service 314 may be configured to act as a routing service to the various target users of the received messages with outperforming any filtering and/or formatting, thereby leaving any filtering or formatting up to the individual users' mobile devices. Moreover, as will be further discussed below in regard to FIG. 6, a user's mobile device, such as mobile device 304, may be configured to perform and formatting whether or not the messaging service 314 performs the same.

Turning out to FIG. 6, this figure illustrates a flow diagram of an exemplary routine 600 as implemented on a user's mobile device, such as mobile device 304, for receiving messages to be displayed on the user's multi-use card 302. Beginning at block 602, the mobile device 304 (by way of one or more processes executing on the mobile device) receives a message 306 for display on the associated multi-use card 302. According to various embodiments of the disclosed subject matter, the message may come from a messaging service 314 (as described above in regard to FIG. 5), or alternatively may come from the network entity (such as network entity 110 or 112) without passing through a messaging service.

At block 604, filtering is applied to the message 306 according to any rules and/or preferences established by the user. If the received message 306 fails to pass the filters, the message 306 is rejected and the routine 600 terminates. Alternatively, if the message 306 passes the filters established by the user, at block 606 the message is formatted for display on the user's multi-use card. At block 608, the process or processes operating on the user's mobile device 304 conduct memory management with regard to the multi-use card 302. As will readily be appreciated, multi-use cards, such as multi-use card 302, will typically have a limited amount of memory 208 such that there may be more associated cards and messages than there is capacity on the card to store them. Thus, one function of the process or processes of the user's mobile device 304 is to manage which associated cards are loaded/stored in the memory of the multi-use card, as well as which messages are downloaded for display to the multi-use card.

At block 610, the message 306 is downloaded to the user's multi-use card. Thereafter, the routine 600 terminates.

Regarding block 604 and 606, these two are identified and FIG. 6 as being optional. According to embodiments of the disclosed subject matter, a process or processes on the user's mobile device 304 may be configured to apply filtering and formatting to received messages. Depending on the abilities of a messaging service 314 or whether the user's mobile device receives messages independent of a messaging service, these optional steps may be implemented or not. Of course, according to various embodiments of the disclosed subject matter, steps 604 and 606 may be implemented on the user's mobile device 304 independent of whether or not a messaging service 314 filters and/or formats a message before forwarding the message to the user's mobile device.

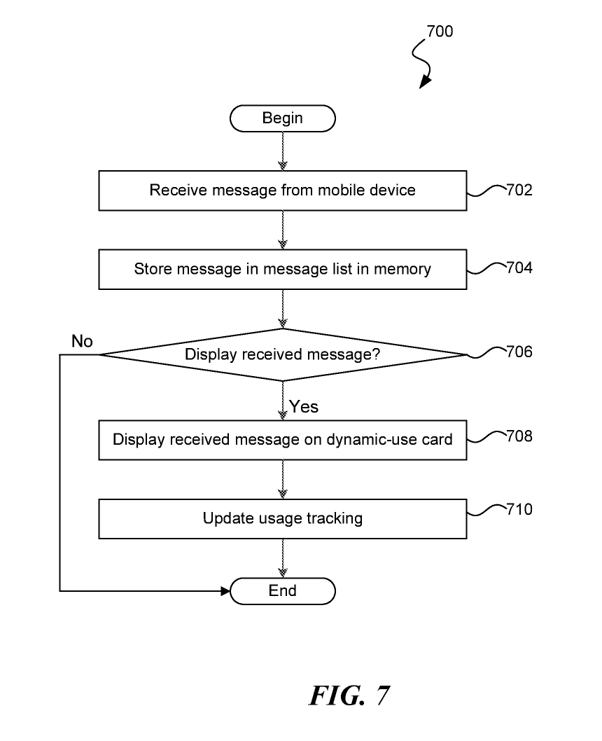

FIG. 7 is a flow diagram illustrating an exemplary routine 700, implemented on a multi-use card, such as multi-use card 302, in regard to receiving messages for display on the card. Beginning at block 702, the multi-use card 302 receives the message 306 from the user's mobile device 304. As indicated above, communication between the multi-use card and the mobile device is carried out by way of near field communications. However, according to various embodiments of the disclosed subject matter, communication between the multi-use card and the mobile device may be carried out using one or more other wireless technologies, such as (by way of illustration and not limitation) Bluetooth, 802.11 protocols, and the like. Further still, in various embodiments of the disclosed subject matter, communication between the multi-use card and the mobile device may be carried out in a wired or physical manner.

At block 704, the received message is stored in the memory of the multi-use card. At decision block 706, determination is made as to whether the received message 306 is to be displayed immediately. If the received message 306 is not indicated to be immediately displayed, or for some other reason the received message should not be immediately displayed, the routine 700 terminates. Alternatively, if the message 306 is to be displayed on the multi-use card 302, the routine 700 proceeds to block 708. At block 708, the received message is displayed in one or more display areas of the multi-use card 302.

At block 710, the usage tracking on the multi-use card is updated. Usage tracking records information such as the time that the multi-use card is configured to display a message and/or operate as an associated card. Tracking usage information (i.e., to which associated cards the multi-use card is configured and which message(s) are display, including times of configuration/display) may be of great value to those network entities that provide the messages, especially network entities sending commercial messages to the multi-use card. After updating the usage tracking information, routine 700 terminates.

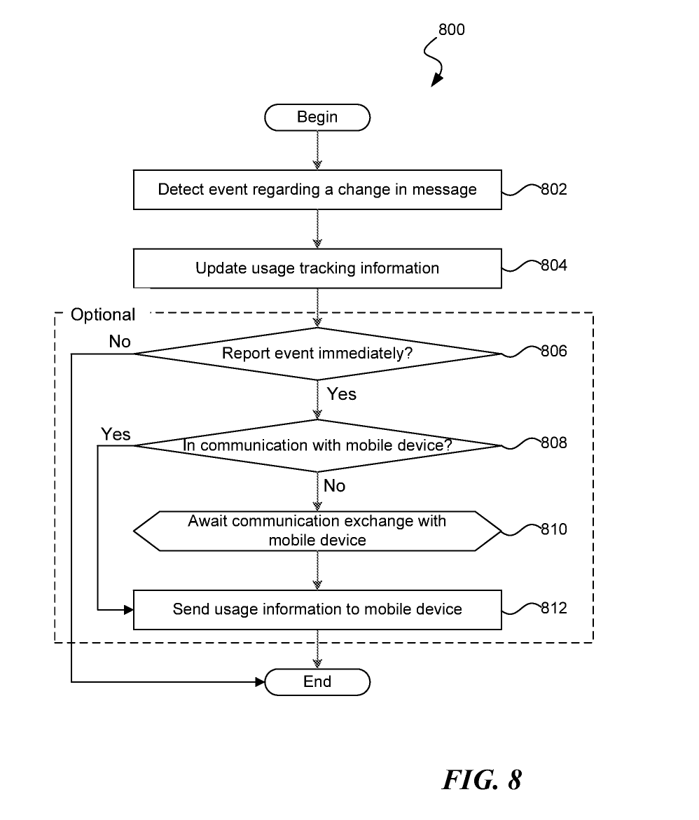

As mentioned above, a person/user associated with a multi-use card may choose to alter the configuration of the multi-use card to another associated card, and/or change the message that is currently displayed by the multi-use card. Changing the message displayed on the multi-use card represents an event that should be reflected in the usage tracking information. FIG. 8 is a flow diagram illustrating an exemplary routine 800, as implemented on the multi-use card, for updating the usage tracking information. Beginning at block 802, a process on the multi-use card detects an event regarding messages, such as an event indicating a change in the displayed message.

At decision block 802, an optional determination is made as to whether or not to immediately report (as tracked usage information) the change in the message on the multi-use card. At block 804, the usage tracking information on the multi-use card is updated, reflecting the change that has occurred.

At decision block 806, a determination is made as to whether to report the detected event immediately or to wait until the mobile device initiates communication and obtains the usage tracking information. It should be appreciated that there may be any number of reasons for which an event such as the change in the display of the message should be reported immediately. When a user makes use of a coupon/message, it may be advantageous to provide the usage information at that moment. Indeed, according to various embodiments of the disclosed subject matter, and network entities submitting a message to the multi-use card may also indicate whether or not immediate notification of use of the contents of that message is desirable. Of course there may be any number of conditions/events upon which it would be advantageous to promptly report tracked usage information. Accordingly, if the tracked usage data is not to be reported immediately, the routine 800 terminates. Alternatively, if the tracked usage data is to be reported immediately, the routine proceeds to decision block 808. At decision block 808 a determination is made as to whether the multi-usage card is in communication with the mobile device. If not, at block 810, the routine awaits until communication is established with the mobile device. Once communication between the multi-use card and the mobile device is available, the tracked usage information is sent/uploaded to the mobile device. Thereafter, the routine 800 terminates.

While not shown in FIG. 8, in addition to tracking usage data and according to additional aspects of the disclosed subject matter, other information may also be captured and reported. By way of illustration, under appropriate user consents and permissions, elements of the multi-use card may also capture information regarding transactions. In particular, one or more elements of a multi-use card may be used to capture information regarding point-of-sale (POS) transactions (such as associated card, amount, time, place), store the captured transaction information on the multi-use card and upload the captured transaction information to a service for purchase tracking, personal record keeping, updating of applicable loyalty rewards, and analyzed to provide more specific, targeted offerings and advertisements.

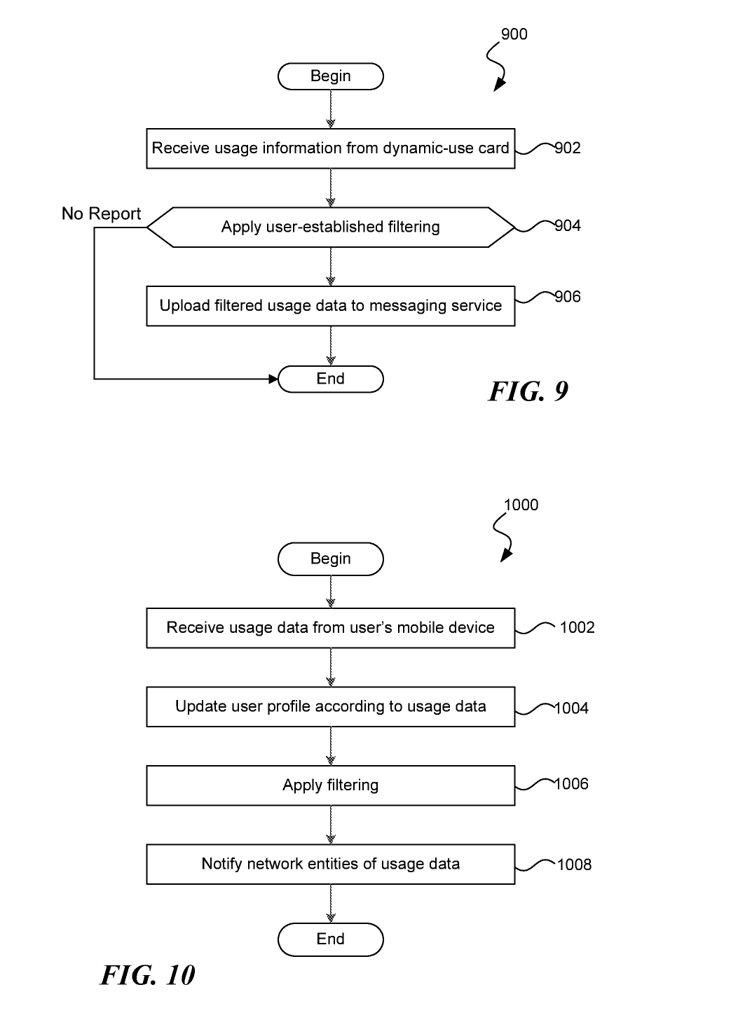

FIG. 9 is a flow diagram illustrating an exemplary routine 900, as executed on a mobile device, for receiving usage information from a multi-use card and reporting the information to a messaging service. Beginning at block 902, the mobile device receives the tracked usage information from the multi-use card. As suggested above, the multi-use card may initiate the upload of the information to the mobile device. Alternatively, a process on the mobile device may periodically obtain the tracked usage data from the multi-use card. In either event, after obtaining the tracked usage information from the multi-use card, at block 904, user established rules and preferences for filtering reported information are applied. The result of applying the user established rules and/or preferences is that some tracked usage information may not be reported, as indicated by the “no report” arrow from block 904. If, however, there is tracked usage information/data to be reported, at block 906 the mobile device uploads the filtered data to the messaging service for distribution to network entities. Thereafter, routine 900 terminates. Of course, in the particular embodiment where a messaging service is not utilize, the mobile device would report the filtered usage data directly to one or more network entities as described below in regard to FIG. 10.

FIG. 10 is a flow diagram illustrating an exemplary routine 1000, as executed by a messaging service, for receiving track usage information and reporting the information to one or more network entities. Beginning at block 1002, usage data from the user's mobile device is received. At block 1004, the messaging service may optionally update a user profile corresponding to the user according to the tracked usage data. At block 1006, filtering is applied to the usage data according to any rules and/or preferences established by the user. At block 1008, network entities are identified and the usage data, as filtered by the previous step, it is submitted to the network entities. Thereafter, routine 1000 terminates.

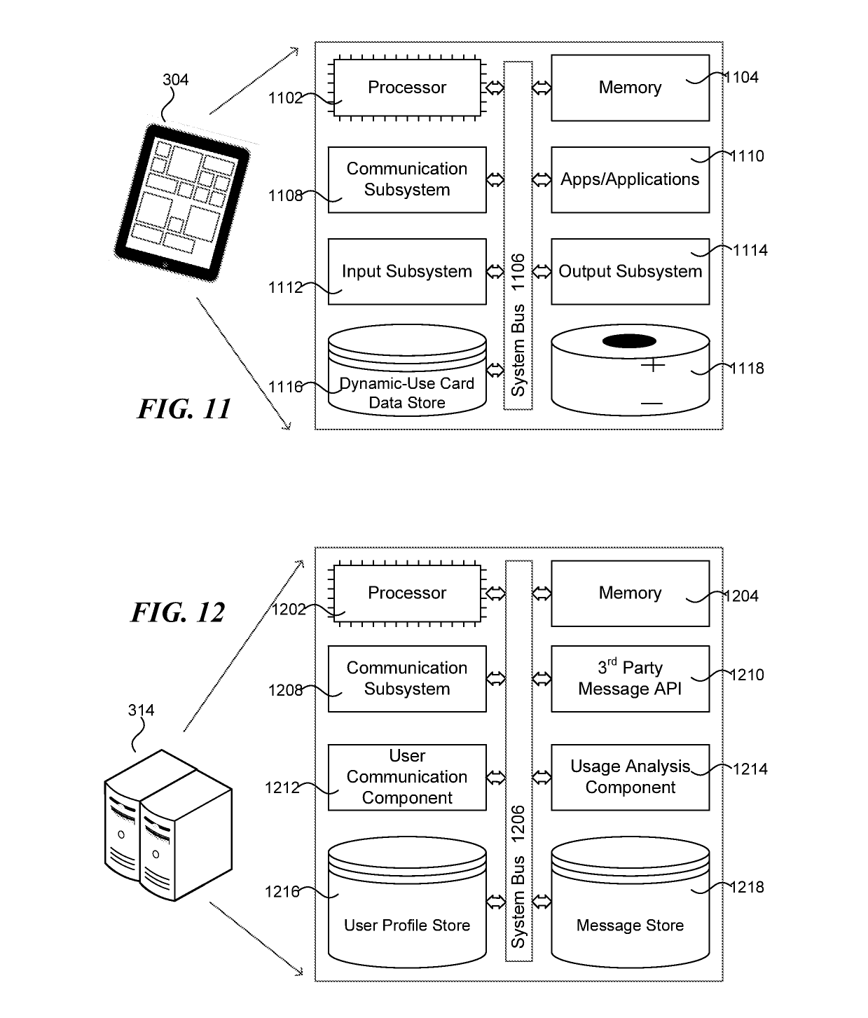

Regarding routines 500-1000, while these routines are expressed in regard to discrete steps, these steps should be viewed as being logical in nature and may or may not correspond to any actual and/or discrete steps of a particular implementation. Nor should the order in which these steps are presented in the various routines be construed as the only order in which the steps may be carried out. Moreover, while these routines include various novel features of the disclosed subject matter, other steps (not listed) may also be carried out in the execution of the routines. Further, those skilled in the art will appreciate that logical steps of these routines may be combined together or be comprised of multiple steps. Steps of routines 500-1000 may be carried out in parallel or in series. Often, but not exclusively, the functionality of the various routines is embodied in software (e.g., applications, system services, libraries, and the like) that is executed on computing hardware and/or systems as described below in regard to FIGS. 11 and 12, as well as in regard to FIG. 2. In various embodiments, all or some of the various routines may also be embodied in hardware modules, including but not limited to system on chips, specially designed processors and or logic circuits, and the like on a computer system.

While many novel aspects of the disclosed subject matter are expressed in routines embodied in applications (also referred to as computer programs), apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions store stored on the computer-readable storage devices are executed, they carry out various steps, methods and/or functionality, including those steps, methods, and routines described above in regard the various routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

Turning now to FIG. 11, FIG. 11 is a block diagram illustrating exemplary components of a mobile device 304 suitable for implementing aspects of the disclosed subject matter. As shown in FIG. 11, the mobile device 1100 includes a processor 1102 (or processing unit) and a memory 1104 interconnected by way of a system bus 1106. As those skilled in the art will appreciated, memory 1104 typically (but not always) comprises both volatile memory and non-volatile memory. Volatile memory retains or stores information so long as the memory is supplied with power. In contrast, non-volatile memory is capable of storing (or persisting) information even when a power supply is not available. Generally speaking, RAM and CPU cache memory are examples of volatile memory whereas ROM and memory cards are examples of non-volatile memory.

The processor 1102 executes instructions retrieved from the memory 1104 in carrying out various functions, particularly in regard to managing a person's multi-use card. The processor 1102 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: personal computers, e.g., desktop computers, laptop computers, tablet computers, phablets, e-book readers, and the like; handheld computing devices such as smartphones, personal digital assistants, and the like; etc.

The system bus 1106 provides an interface for the various components of the mobile device to inter-communicate. The system bus 1106 can be of any of several types of bus structures that can interconnect the various components (including both internal and external components).

The exemplary mobile device 304 further includes a communication subsystem 1108 that is suitable for communicating other devices as set forth above, including a person's multi-use card by way of via near field communications. One or more apps and/o applications 1110 are included to manage aspects of the multi-use card, including memory management, obtaining tracked usage data, and the like. Additionally, one or more apps and/or applications 1110 are included to manage the power source of the multi-use card 302, including generating near field communication signals for charging the power source of the multi-use card. While the applications 1110 are illustrated as being a distinct component, according to various embodiments, the apps/applications 1110 may be stored within the memory 1104.

An input subsystem 1112 provides the user input mechanisms for a person to interact with the user mobile device. Such input mechanisms include, by way of illustration and not limitation, touch-sensitive surfaces, keyboards, pointing devices, audio-input devices, and the like. An output subsystem 1114 typically includes visual and audio output devices. Often, though not exclusively, the output subsystem 1114 includes a display surface for presenting visual information and one or more speakers for providing audio output. Of course, the elements mentioned above in regard to the input subsystem 1112 and the output subsystem 1114 should be viewed as illustrative and not limiting as there are other mechanisms for providing accepting user input and providing output to the user.

Also included in the exemplary mobile device 304 is a multi-use card data store 1116. Information, regarding both associated cards and messages, that are stored on the corresponding multi-use card may also be stored and managed from the multi-use card data store 1116. Indeed, associated cards and/or messages that are not necessarily loaded onto the multi-use card may be stored in the multi-use card data store 1116. Still further, the exemplary mobile device 304 typically includes a power source 1118 for providing power to the device when the device cannot be attached to an external power source. While the multi-use card data store 1116 is illustrated as being separate from the memory 1104, this is for illustration purposes. According to various embodiments, the multi-use card data store 1116 is a component of the memory 1104.

FIG. 12 is a block diagram illustrating exemplary components of a messaging service 314 suitable for implementing aspects of the disclosed subject matter. The messaging service 314 includes a processor 1202 (or processing unit) and a memory 1204 interconnected by way of a system bus 1206. As discussed above, the memory 1204 typically (but not always) comprises both volatile memory and non-volatile memory.

The processor 1202 executes instructions retrieved from the memory 1204 in carrying out various functions, particularly in regard to managing a person's multi-use card. The processor 1202 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini- and mainframe computers; personal computers, e.g., desktop computers, laptop computers, tablet computers, phablets, e-book readers, and the like.

The system bus 1206 provides an interface for the various components of the messaging service 314 to inter-communicate. The system bus 1206 can be of any of several types of bus structures that can interconnect the various components (including both internal and external components). The communication subsystem 1208 provides the ability to communicate (via physical, wired, and/or wireless connections) over the network with other devices including network entities (such as network entities 310-312) and the user mobile device 304 discussed above. The 3^{rd} party message API 1210 provides the interface by which network entities (such as network entities 310-312) can submit message for display on the multi-use card 302, as well as receive tracked usage data.

In contrast to the 3^{rd} party message API 1210, the user communication component 1212 provides the interfaces by which a user (of a multi-use card) can interact with the messaging service 314, including but not limited to setting filtering rules and/or preferences, identifying mobile devices associated with the user, and the like. The usage analysis component 1214 is configured to track usage data from the user's multi-use card 302 and can update preferences and/or rules associated with the user according to the analysis. In this way, the messaging service 314 can improve the filtering and selection of messages from networked entities that are delivered to the user's multi-use card.

Also included in the exemplary messaging service 314 is a user profile store 1216 that stores profile information corresponding to a plurality of users. This profile information may include, by way of illustration and not limitation: user preferences; rules for restricting out or favoring messages; mobile devices associated with the user; and the like. Still further, the messaging service 314 may include a message store 1218 for storing one or more messages from network entities for delivery to a user's multi-use card.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A method, as implemented on a multi-use card including at least a processor, a memory, and a display area on the multi-use card, for displaying a message from a third party, the method comprising:
configuring the multi-use card to operate as one of a plurality of associated cards stored in the memory on the multi-use card;
receiving a message by way of near field communications from a mobile device, wherein the multi-use card and the mobile device are both associated with a user;
storing the received message in the memory of the multi-use card; and
displaying the message by way of the display area on the multi-use card.

2. The method of claim 1, wherein display of the message is independent of the multi-use card being selectively configured as an associated card.

3. The method of claim 1, wherein the plurality of associated cards comprise at least one of a credit card, a loyalty card, a membership card, or an access card.

4. The method of claim 1 further comprising selectively reconfiguring the multi-use card to operate as a second of the plurality of associated cards.

5. The method of claim 4, wherein the user selectively reconfigures the multi-use card by way of user controls on the multi-use card.

6. The method of claim 1 further comprising selectively displaying a second message on the multi-use card from a plurality of messages in the memory of the multi-use card.

7. The method of claim 6, wherein the second message displayed in a second display area on the multi-use card other than the display area in which the received message is displayed.

8. The method of claim 1, wherein the received message is a commercial message comprise at least one of an advertisement, an offer, or a coupon.

9. The method of claim 8, wherein the received message includes coded data which, when displayed on the multi-use card, may be optically scanned.

10. The method of claim 9, wherein the commercial message comprises one of a coupon, an advertisement, a rebate, and loyalty reward.

11. A selectively configurable multi-use card, the multi-use card comprising:
a processor for processing executable code stored on the multi-use card;
a memory, wherein the memory is configured to store information for configuring the multi-use card to operate as any one of a plurality of associated cards;
a communication antenna configured to send and receive near field communications with a mobile device;
a battery configured with circuitry to provide power to components of the multi-use card, and further configured with circuitry to charge the battery from energy harvested from received near field communications; and
a display area on a surface the multi-use card for displaying a messages on the multi-use card received from an external device by way of near field communications via the communication antenna;
wherein the multi-use card is selectively configurable to operate as first associated card of the plurality of associated cards.

12. The multi-use card of claim 11 further comprising a second display area, the second display area being positioned on the opposite side of the multi-use card than the display area.

13. The multi-use card of claim 12, wherein the message received from an external device by way of near field communications is stored in the memory as one of a plurality of messages on the multi-use card.

14. The multi-use card of claim 13, wherein the second display area displays a second message from the plurality of messages stored in the memory.

15. The multi-use card of claim 11 further comprising a user control for selecting a second message of the plurality of messages for display on the display area of the multi-use card.

16. The multi-use card of claim 11 further comprising a user control for selectively reconfiguring the multi-use card operate as a second associated card of the plurality of associated cards.

17. The multi-use card of claim 11, wherein the multi-use card is configured to send usage tracking information comprising information regarding the configuration of the multi-use card as associated cards and messages displayed on the display area to an external device by way of near field communications.

18. A computer system for managing a dynamic use card, the computer system comprising:
a processor for processing executable code stored on the computer system;
a memory, wherein the memory is configured to store executable code for managing the multi-use card, data of a plurality of associated cards of the multi-use card, and a plurality of messages from a plurality of third parties for display on the multi-use card; and
communication subsystem for communicating with third parties, including receiving messages for display on the multi-use card, and for sending and receiving communications with the multi-use card, wherein communication with the dynamic use card are conducted by way of near field communications;
wherein the memory comprises one or more applications for managing storage of associated cards and messages on the multi-use card, and further includes one or more applications managing the power source of the multi-use card, including generating communications for charging the power source of the multi-use card by way of harvesting energy from near field communications.

19. The computer system of claim 18, wherein the memory further comprises one or more apps or applications for filtering the received messages from the third parties and for formatting messages for display on a display area of the multi-use card.

20. The computer system of claim 19, wherein the memory further comprises one or more apps or applications for obtaining tracked usages data with regard to the configuration of the multi-use card as associated cards and the display of messages on the multi-use card.
